(19) United States
(12) Patent Application Publication
(10) Pub. No.: US 2016/0335338 A1
(43) Pub. Date: Nov. 17, 2016

(54) CONTROLLING REPLICATION OF IDENTITY INFORMATION

(71) Applicant: HEWLETT-PACKARD DEVELOPMENT COMPANY, L.P., Houston, TX (US)

(72) Inventor: Michael B Beiter, Fort Collins, CO (US)

(21) Appl. No.: 15/112,393

(22) PCT Filed: Jan. 20, 2014
(86) PCT No.: PCT/US14/12176

§ 371 Date: Jul. 18, 2016

(51) Int. Cl. G06F 17/30; G06F 21/62

(52) U.S. Cl. CPC G06F 17/30575; G06F 21/6218

(57) ABSTRACT

Access of a resource or service requested by a user is authorized by using identity information of at least one of plural records containing identity information for respective users. Replication of portions of the records containing identity information for the respective users among different zones is controlled, where the controlling of the replication is based on metadata individually associated with respective portions of the records. Each of the metadata identifies at least one zone to which a respective portion of a respective one of the records is allowed to be replicated.

### BACKGROUND

A cloud system includes resources or services that can be shared by customers of a provider of the cloud system. Resources can include processing resources, storage resources, communication resources, and so forth. Services can be provided by applications or other machine-executable instructions. The cloud system allows its resources or services to be accessed by customers on-demand.

### BRIEF DESCRIPTION OF THE DRAWINGS

Some implementations are described with respect to the following figures.

FIG. 1 is a schematic diagram of an example arrangement that includes an identity management system coupled to client devices, in accordance with some implementations.

FIG. 2 is a schematic diagram illustrating replication, by a replication control engine, identity information record fields between multiple zones, in accordance with some implementations.

FIG. 3 is a flow diagram of a system process according to some implementations.

FIG. 4 is a block diagram of an example arrangement that includes a cloud system and client devices, according to further implementations.

FIG. 5 is a block diagram of an example cloud system according to some implementations.

### DETAILED DESCRIPTION

The infrastructure of a cloud system can be owned by or managed by a provider, which can be an entity such as a business concern, government agency, educational organization, or individual. The infrastructure of the cloud system can be located at a particular geographic site, or can be distributed across multiple geographic sites. The infrastructure includes cloud resources and cloud services that are made available to customers of the provider of the cloud system. Such customers, which are also referred to as tenants, can be located anywhere, so long as they are able to access the cloud system over a network. A tenant can refer to an individual user or a collection of users, such as users who are members of a business concern, a government agency, or an educational organization.

Cloud resources can include any one or some combination of the following: processing resources (which can include processors of one or multiple computers), storage resources (which can include storage devices such as disk-based storage devices or solid state storage devices), communication resources (which can include communication devices to allow communications by users, where examples of communication devices can include routers, switches, communication establishment servers, etc.), and other resources.

In addition to cloud resources, the cloud system can also provide cloud services, such as web services, that can be invoked by users of tenants of the cloud system. A user of a tenant can refer to a machine or a human. A cloud service refers to a functionality that can be invoked by a tenant. The functionality can be provided by machine-readable instructions. A web service refers to a service that is accessible over a network, such as the Internet.

Although reference is made to a cloud system in the present discussion, is noted that techniques or mechanisms according to some implementations are also applicable to other types of systems that can include resources and/or services that can be shared by multiple tenants.

A cloud system can include an identity management system that stores user identity information to enable authentication of users attempting to access the cloud system, and authorization of access to requested resources or services of the cloud system. Other entities can interact with the identity management system to perform the authorization and authentication. The user identity information of the identity management system can define privileges relating to the access of the resources and services of the cloud system. A privilege can refer to the permission of a given user to perform an action, which can involve accessing a resource or service of the cloud system.

The identity management system also provides privileges associated with the ability to create, read, update, or delete profile information of users. The profile information of a user maintained by the identity management system can include various types of user data, including a users name, email address, login name (for logging into the cloud system), one or multiple authentication credentials that allow a user to access the cloud system (examples of an authentication credential can include a password, biometric information of the user, a secure key, and so forth), and so forth. The profile information of users can also be part of the user identity information.

A “muiti-tenant” identity management system is an identity management system that is able to perform identity management for multiple tenants, such as multiple tenants of a cloud system.

A cloud system can be distributed geographically, such as distributed across different cities, different states or provinces, or different countries. To provide a cloud system that is available and scalable as users move around the different geographic locations across which the cloud system is distributed, identity information maintained by the identity management system of the cloud system can be replicated across multiple zones. A “zone” can refer to a respective geographic region defined by a specific boundary. The boundary can be a legal boundary, where a geographic region on one side of the boundary is part of a first legal jurisdiction, while the geographic region on the second side of the boundary can be a second legal jurisdiction. As an example, the legal boundary can be a boundary that defines the boundary between two different states or provinces. Alternatively, the legal boundary can be a boundary between different countries, or other geographic regions, such as cities, school zones, and so forth.

Different legal jurisdictions may have different regulations or laws governing the manner in which user identity information of an identity management system is to be stored or used. Such regulations or laws can include privacy protection laws or regulations, as examples. Due to differing regulations or laws governing the manner in which user identity information is to be stored or used, the control of replicating user identity information across different zones can be complex.

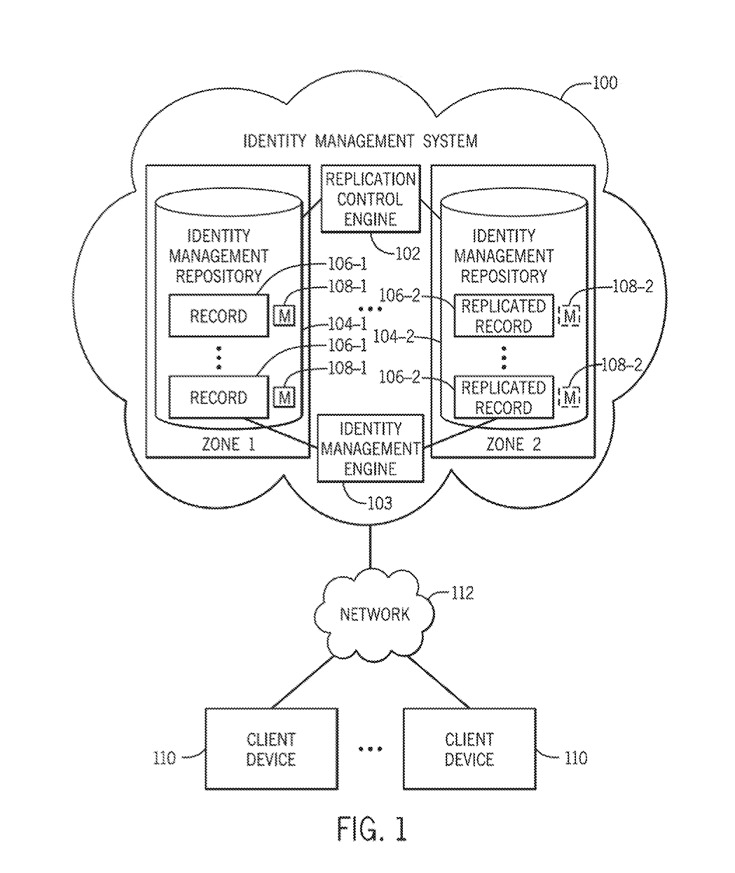

In accordance with some implementations, as shown in FIG. 1, a replication control engine 102 that is part of an identity management system 100 can be used to control replication, across multiple zones, of portions of records containing user identity information of the identity management system 100. The identity management system 100 can be distributed across multiple zones. Replication of user identity information across the multiple zones allows for more efficient authentication of users, authorization of access of cloud resources and/or cloud services, and other use of the available information stored in the identity management system. Note that replicated user identity information is not simply stored in a remote zone; such replicated identity information (e.g. login credentials of users) can be retrieved from the remote zone and used for performing authentication and authorization of access by users of a cloud system, for example.

In FIG. 1, zone 1 and zone 2 are depicted. In other examples, there can be more than two zones across which the identity management system 100 can be distributed.

Each zone includes a respective identity management repository (zone 1 includes an identity management repository 104-1 and zone 2 includes an identity management repository 104-2). The identity management repository 104-1 includes various records 106-1, where each record 106-1 stores the user identity information of a respective user. Each record 106-1 can include identity information that can be used to authenticate the respective user or to authorize access to a cloud resource or cloud service as requested by the user. In some cases, each record 106-1 can also include information in addition to user identity information.

As depicted in FIG. 1, the identity management repository 104-1 further stores metadata 108-1 associated with each respective record 106-1. The metadata 108-1 can be used by the replication control engine 102 to control replication of the corresponding record 106-1 (or of a portion of the corresponding record 106-1) to another zone. In the example of FIG. 1, each metadata 108-1 can control whether or not the corresponding record 106-1 (or a portion of such record) is replicated to zone 2 (and/or to any other zone). As depicted in FIG. 1, the identity management repository 104-2 in zone 2 stores various replicated records 106-2. The replicated records 106-2 contain copies of information (including user identity information) included in at least some of the records 106-1 stored in the identity management repository 104-1 in zone 1.

In some implementations, each metadata 108-1 can be in the form of a zone replication list (or other data structure) that can identify one or multiple zones to which a respective record (or portion of a record) is to be replicated.

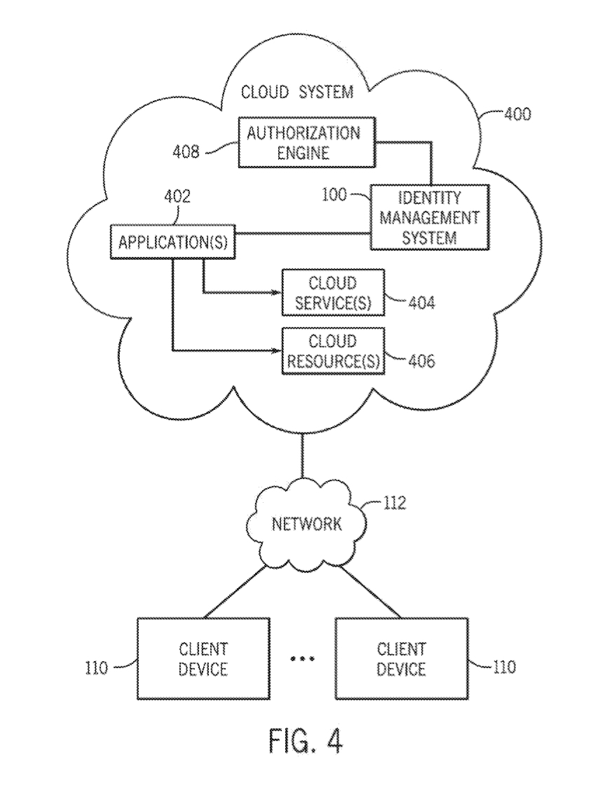

Information stored in at least one of the identity management repositories 104-1 and 104-2 can be accessed by an identity management engine 103 in the identity management system 100, in response to a request from a client device 110 coupled to the identity management system 100 over a network 112. The request can be for a cloud resource and/or a cloud service of a cloud system (shown in FIG. 4). In response to the request, the identity management engine 103 can retrieve user identity information from a respective identity management repository (in one of the zones) to authenticate a user and authorize to access of the cloud resource and/or cloud service. The identity management repository accessed in response to the request can depend upon the location of the user or other entity who initiated the submission of the request. For example, zone 1 can correspond to first country, while zone 2 can correspond to a second country. If the user is located in the first country, then the identity management engine 103 would respond to the request by accessing the corresponding user identity information in the identity management repository 104-1 in zone 1. Later, if the user is visiting the second country, or if an entity located in a different country wants to access the cloud resource and/or cloud service, then the identity management engine 103 would respond to a request to access a cloud resource and/or cloud service by accessing the corresponding user identity information in the identity management repository 104-2 in zone 2.

Each of the engines (including engines 102 and 103 in FIG. 1 and an authorization engine 406 in FIG. 4, for example) may be any combination of hardware and programming to implement the functionalities of the respective engine. Such combinations of hardware and programming may be implemented in a number of different ways. For example, the programming for an engine may include executable instructions stored on a non-transitory machine-readable storage medium and the hardware for the engine may include processor(s) to execute those instructions. In such examples, the machine-readable storage medium may, store instructions that, when executed by the processor(s), implement functionalities of the engine. The machine-readable storage medium storing the instructions may be integrated in a computing device including the processing resource to execute the instructions, or the machine-readable storage medium may be separate but accessible to the computing device and the processing resource. The processing resource may include one processor or multiple processors included in a single computing device or distributed across multiple computing devices. In other examples, the functionalities of any of the engines may be implemented in the form of electronic circuitry.

In accordance with some implementations, a metadata 108-1 can provide fine-grained control of replication of information in the respective record 106-1. The fine-grained control can be of individual records, in which where the replication control engine 102 can, decide whether or not a respective individual record 166-1 is to be replicated to another zone. Alternatively, the replication control can be of portions of the records, in which the metadata 108-1 can indicate whether or not some portion (less than the entirety) of a respective record 106-1 is to be replicated to another zone. Providing fine-grained control provides more flexible control than systems in which control of replication is of an entire collection of records, such as records of all users of, a given tenant of a cloud system.

In addition to replication control information that identifies one or multiple zones to which user identity information can be replicated, the metadata 108-1 can also include access control information. Access control information can control the manner in which the respective record 106-1 (or portion of the respective record 106-1) in the identity management repository 104-1 is accessed. For example, the access control information can be in the form of an access control list that specifies that a specific entity (or multiple specific entities) is (are) allowed to access and/or modify the respective record (or portion of the respective record). This provides fine-grained access control of information stored in the records of the identity management repository 104-1. More generally, an access control list (or other data structure) can specify entities and permissions of the respective entities with respect to a corresponding record (or portion of such record) of user identity information. Examples of entities include users, groups of users (such as tenants), and other machines, applications, or other entities.

Access control lists can also be used with a cryptographic mechanism to enhance security. The access control lists can be encrypted using an encryption key. Secret sharing can be provided by the cryptographic mechanism to provide keys for use in decrypting the encrypted access control lists.

In further examples, cryptographic mechanisms can use a digitally signed access policies (as specified in access control information in the metadata 108-1) and enforcement based on signatures. As an example, a policy administration and enforcement mechanism such as an eXtensible Access Control Markup Language (XACML) mechanism can be used. Such a mechanism can include a policy administration point that creates digitally signed access policies. When an entity attempts to access user identity information, a policy decision point, can decide based on a digitally signed access policy whether such an access can be granted. A digital signature applied to the access policy beforehand by the policy administration point allows the policy decision point to validate the access policy independently from the policy administration point. The digital signature can be an asymmetric digital signature (e.g. Digital Signature Algorithm or DSA signature), in which case the policy administration point and the policy decision point do not have to share common cryptographic secret.

As yet further examples, access policies that have been protected using a hash message authentication code (HMAC) can be used, and enforcement can be based on the HMACs. Instead of protecting an access policy as described above by using asymmetric digital signatures, a policy administration point and a policy decision point can share a common cryptographic secret, which allows validation of access policies using a symmetric HMAC technique, such as described in Request for Comments (RFC) 2104, entitled “HMAC: Keyed-Hashing for Message Authentication,” dated in February 1997.

As further shown in FIG. 1, each of the replicated records 106-2 in the identity management repository 104-2 in zone 2 can also be associated with respective metadata 108-2, which can include replication control information to control replication of the respective replicated record 106-2 for portion of such replicated record). Each metadata 108-2 can also include access control information to control access of the replicated record 106-2 (or portion of the replicated record).

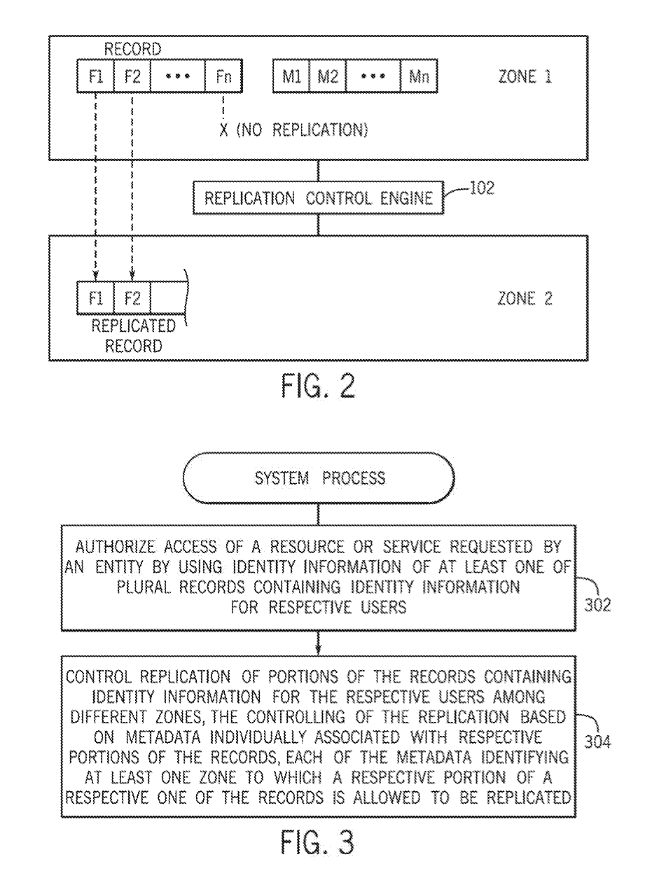

In some examples, as shown in FIG. 2, each record 106-1 can include multiple fields F1, F2, . . . , Fn (n>1). The metadata 108-1 can provide replication control for each of the fields, or each group of multiple groups of the fields. In such examples, as shown in FIG. 2, the metadata 108-1 includes multiple parts (M1, M2, . . . , Mn), where each metadata part Mi (i=1, . . . , n) controls replication of the respective field Fi. Alternatively, each metadata part Mi can control replication of a respective group of fields.

In the example of FIG. 2, metadata parts M1 and M2 indicate that fields F1 and F2 of the respective record are to be replicated from zone 1 to zone 2. However, metadata part Mn indicates that field Fn of the respective record is not to be replicated from zone 1 to zone 2. Replication control of the fields F1, F2, . . . , Fn is performed by the replication control engine 102 based on the metadata parts M1, M2, . . . , Mn.

In some implementations, zone 1 can be considered a home zone (from the perspective of a given user), while zone 2 can be considered a replication zone. The home zone acts as a master zone, and includes one or multiple computer nodes (also referred to as “master computer nodes”) that “own” user identity information of an identity management system Within the home zone, replication of user identity information of the identity management system can be unrestricted. Also, each of the master computer nodes in the home zone being able to read and write records of the identity management system.

One or multiple computer nodes in zone 2 (the replication zone from the perspective of the given user) can be referred to as “slave computer nodes.” Slave computer nodes can be configured to have read-only access to user identity information replicated from the home zone.

Although some implementations enable just read-only access of replicated records of user identity information, other implementations can allow modification of replicated user identity information. In the latter implementations, replicated user identity information that has been modified can be back-propagated from the replication zone to the home zone. The back-propagation of replicated user identity information that has been modified can be according to one or multiple restrictions (e.g. restrictions relating to ensuring security and/or consistency of the user identity information in the home zone, or restrictions relating to handling of user identity information pursuant to applicable regulations or laws, or other restrictions).

FIG. 3 is a flow diagram of an example of a process according to some implementations. The process of FIG. 3 authorizes (at 302) access of a resource or service (e.g. cloud resource or cloud service of a cloud system) requested by an entity by using user identity information in at least one of records stored in an identity management repository of a first zone (e.g. identity management repository 104-1 in zone 1 of FIG. 1).

The process of FIG. 3 controls (at 304) replication of portions of the records containing user identity information among different zones, where the controlling of the replication is based on metadata (e.g. 108-1 in FIG. 1) individually associated with respective portions of the records. Replication control can be performed by the replication control engine 102 of FIG. 1.

In alternative implementations, user identity information of an identity management system can be divided, into multiple portions that are replicated according to respective different replication models. For example, a first portion of the user identity information can be replicated according to a first replication model, while a second portion of the user identity information can be replicated according to a second, different replication model. With the first replication model, modification of user identity information is allowed only in the home zone; replicated user identity information is read-only in a replication zone. With the second replication model, replicated user identity information can be modified in a replication zone.

By using the first replication model, real-time consistency can, be maintained for the first portion of the user identity information. Maintaining real-time consistency of a given portion of user identity information can refer to ensuring that multiple instances (instance in the home zone and instance in each replication zone) of the given portion of the user identity information is consistent across all of the zones where the multiple instances are kept. Thus, at given point in time, the instance of the given portion of the user identity information in any replication zone would be consistent with the instance of the given portion of the user identity information in the home zone. The first replication model can be applied to user identity information that is considered more important or critical, such as a user name, an authentication credential, and so forth.

The second replication model supports eventual consistency for the second portion of the user identity information. Maintaining eventual consistency for a given portion of the user identity information can refer to gradually making a first instance of the given portion of the user identity information consistent with a second instance of the given portion of the user identity information. At any point in time, it is possible that the multiple instances of the given portion of the user identity information have different values. However, the multiple instances of the given portion of the user identity information will become eventually consistent.

FIG. 4 is a block diagram of another example arrangement, which includes a cloud system 400 that is coupled over the network 112 to the client devices 110. The cloud system 400 includes the identity management system 100 discussed in connection with FIG. 1. In addition, the cloud system 400 includes an authorization engine 408 (e.g. a sign-on engine) that is able to use user identity information maintained by the identity management system 100 to authorize access of cloud service(s) 404 and cloud resource(s) 406. The authorization engine 408 can perform the authorizing at 302 in FIG. 3.

Also, the cloud system 400 can include one or multiple applications 402 that manage access to cloud service(s) 404 and cloud resource(s) 406. The cloud service(s) 404 and cloud resource(s) 406 can be accessed on demand by the client devices 110, by accessing the application(s) 402.

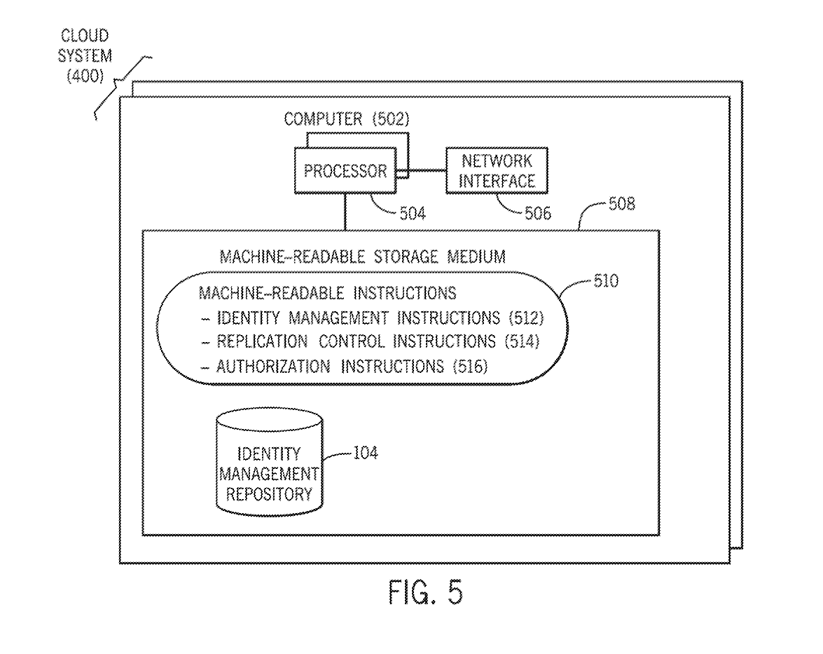

FIG. 5 is a block diagram of an example cloud system 400 that includes multiple computers 502, which can be distributed across multiple zones according to some implementations. Each zone can include one or multiple computers 502. Each computer 502 includes one or multiple processors 504, which can be connected to a network interface 506 to allow the computer 502 to communicate over a data network.

The processor(s) 504 can be coupled to a non-transitory machine readable storage medium (or storage media) 508, which can store instructions and other information. The instructions can include machine-readable instructions 510, which can include identity management instructions 512 (that are part of the identity management engine 103 of FIG. 1), replication control instructions 514 (that are part of the replication control engine 102 of FIG. 1), and authorization instructions 516 (that are part of the authorization engine 408 of FIG. 4). The machine-readable instructions 510 are executable on the processor(s) 504. A processor can include a microprocessor, microcontroller, processor module or subsystem, programmable integrated circuit, programmable gate array, or another control or computing device.

The storage medium (or storage media) 508 can also store a respective identity management repository 104 (such as any of the repositories) discussed above. As used herein, a “machine-readable storage medium” may be any electronic, magnetic, optical, or other physical storage apparatus to contain or store information such as executable instructions, data, and the like. For example, any machine-readable storage medium described herein may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
authorizing, by a system including a processor, access of a resource or service requested by a user by using identity information of at least one of plural records containing identity information for respective users; and
controlling, by the system, replication of portions of the records containing identity information for the respective users among different zones, the controlling of the replication based on metadata individually associated with respective portions of the records, each of the metadata identifying at least one zone to which a respective portion of a respective one of the records is allowed to be replicated, wherein a replicated version of a portion of one of the records that is replicated to a given one of the zones is useable in the given zone to authorize access of a resource or service.

2. The method of claim 1, wherein a portion of a given one of the records that a respective one of the metadata is associated with includes less than the entirety of the identity information of the given record.

3. The method of claim 2, wherein the given record includes a plurality of fields, wherein the portion of the given record that the respective metadata is associated with includes less than all of the plurality of fields.

4. The method of claim 1, wherein a portion of a given one of the records that a respective one of the metadata is associated with includes the entirety of the identity information of the given record.

5. The method of claim 1, wherein at least some of the different zones are associated with different legal jurisdictions.

6. The method of claim 1, wherein controlling the replication of the portions of the records comprises causing a portion of a first of the records that is replicated from a first of the zones to a second of the zones to be read-only in the second zone.

7. The method of claim 1, further comprising:
updating a portion of a first of the records in a first of the zones in response to modification of a replicated version of the portion of the first record in a second of the zones.

8. The method of claim 1, wherein controlling the replication of the portions of the records comprises causing replication of a portion of a first of the records from a first of the zones to a second of the zones, wherein a first subset of the portion of the first record is modifiable only in the first zone, and wherein a second subset of the portion of the first record is read-only in the second zone.

9. The method of claim 1, further comprising:
controlling, by the system, access of the identity information in the records based on access control information associated with the records.

10. The method of claim controlling the replication of the portions of the records comprises controlling replication of a first portion of a first of the records according to a first replication model, and controlling replication of a second portion of the first record according to a second replication model.

11. A distributed system comprising:
a plurality of identity management repositories for storing corresponding records containing user identity information for respective users, the plurality of identity management repositories located in respective zones;
an identity management engine including a processor and to provide the user identity information in at least one of the identity management repositories for controlling access of a resource or service; and
a replication control engine including a processor and to:
control replication of portions of the records in a first of the identity management repositories in a first of the zones to a second of the identity management repositories in a second of the zones, the controlling of the replication based on metadata individually associated with respective portions of the records in the identity management repository, each of the metadata identifying at least one zone to which a respective portion of a respective one of the records in the first identity management repository is allowed to be replicated, wherein a replicated version of a portion of one of the records that is replicated to the second identity management repository in the second zone is useable to authorize access of a resource or service.

12. The distributed system of claim 11, wherein the metadata further includes access control information to control access permissions of respective records in the first identity management repository.

13. The distributed system of claim 11, wherein a first of, the records in the first identity management repository includes a plurality of fields, and wherein one of the metadata associated with the first record includes a plurality of metadata parts associated with the respective fields or respective groups of the fields.

14. The distributed system of claim 13, wherein a first metadata part of the plurality of metadata parts specifies that a first of the plurality of fields or a first group of the plurality of fields is to be replicated to at least another zone, and wherein a second metadata part of the plurality of metadata parts specifies that a first of the plurality of fields or a first group of the plurality of fields is not to be replicated to any other zone.

15. An article comprising at least one non-transitory machine-readable storage medium storing instructions that upon execution cause an identity management system to:
store plural records containing identity information for respective users, the plural records accessible for authorizing access of a cloud resource or cloud service of a cloud system requested by a user; and
control replication of portions of the records containing identity information for the respective users among different zones, the controlling of the replication based on metadata individually associated with respective portions of the records, each of the metadata identifying at least one zone to which a respective portion of a respective one of the records is allowed to be replicated, wherein a replicated version of a portion of one of the records that is replicated to a given one of the zones is useable in the given zone to authorize access of a cloud resource or cloud service in the cloud system requested by a user.
